(19) United States
(12) Patent Application Publication
(10) Pub. No.: US 2025/0192553 A1
(43) Pub. Date: Jun. 12, 2025

(54) SOLID-STATE POWER CONTROLLER WITH TRANSFORMER SOFT-START

(71) Applicant: VERTIV CORPORATION, Westerville, OH (US)

(72) Inventor: John Nelson Van Fossen, Powell, OH (US)

(21) Appl. No.: 18/842,316

(22) PCT Filed: Mar. 8, 2023
(86) PCT No.: PCT/US2023/014814

§ 371 Date: Aug. 28, 2024

Related U.S. Application Data
(60) Provisional application No. 63/317,670, filed on Mar. 8, 2022.

(51) Int. Cl. H02J 3/14

(52) U.S. Cl. CPC H02J 3/14; H02J 2310/60

(57) ABSTRACT

A power distribution system may include two or more solid-state power controllers (SSPCs) to regulate power between an input power source and two or more loads, where each of the two or more SSPCs is configured to be coupled to a different one of the two or more loads. The system may further include a controller to receive performance specifications for the two or more loads, receive operating conditions from at least one of the input power source or any of the two or more loads as feedback data, and direct the two or more SSPCs to disconnect or connect any of the two or more loads to the input power source based on the feedback data to achieve the performance specifications for the two or more loads.

### CROSS-REFERENCE TO RELATED APPLICATION

The present application claims the benefit under 35 U.S.C. § 119(e) of U.S. Provisional Application Ser. No. 63/317,670 filed Mar. 8, 2022, entitled SOLID-STATE POWER CONTROLLER WITH TRANSFORMER SOFT-START, naming John Van Fossen as the inventor, which is incorporated herein by reference in the entirety.

### TECHNICAL FIELD

The present disclosure is directed to systems and methods for power control and, more particularly, to dynamic solid-state power control.

### BACKGROUND

Dynamic load control in high-power applications remains a critical challenge, particularly for applications requiring high reliability power such as, but not limited to, data centers. For example, energizing a power transformer from a cold start condition typically results in an initial burst of current that may be higher than a nominal power rating of the transformer, which may result in wear on the power transformer itself as well as any connected loads. It is therefore desirable to develop systems and methods to cure the above deficiencies.

### SUMMARY

A power distribution system is disclosed herein. In some embodiments, a power distribution system includes two or more solid-state power controllers (SSPCs) to regulate power between an input power source and two or more loads, where each of the two or more SSPCs is configured to be coupled to a different one of the two or more loads. The system may further include a controller to receive performance specifications for the two or more loads, receive operating conditions from at least one of the input power source or any of the two or more loads as feedback data, and direct the two or more SSPCs to disconnect or connect any of the two or more loads to the input power source based on the feedback data to achieve the performance specifications for the two or more loads.

A power distribution method is disclosed herein. The method may include receiving performance specifications for two or more loads, receiving feedback data from at least one of an input power source or any of the two or more loads, and directing two or more SSPCs to disconnect or connect any of the two or more loads to the input power source based on the feedback data to achieve the performance specifications for the two or more loads. In some embodiments, each of the two or more SSPCs is coupled to a different one of the two or more loads.

The systems and methods disclosed herein may operate based on any type or combination of performance specifications known in the art including, but not limited to, uptime, reliability, billing, or cost specifications. Further, different SSPCs within the power distribution system may provide different performance specifications to attached loads and may prioritize power distribution to various loads. As an illustration, the power distribution system disclosed herein may dynamically disconnect and reconnect loads with lower priorities as necessary to ensure performance of higher-priority loads.

In some embodiments, the power distribution system further provides voltage control when disconnecting or connecting loads including power transformers (e.g., soft-starting) to mitigate or eliminate in-rush currents. In this way, the power distribution system disclosed herein may provide scalable dynamic power control for demanding high-power applications.

### BRIEF DESCRIPTION OF DRAWINGS

The numerous advantages of the disclosure may be better understood by those skilled in the art by reference to the accompanying figures.

FIG. 1 is a block diagram view of a power distribution system, in accordance with one or more embodiments of the present disclosure.

FIG. 2A is a conceptual schematic view of a solid-state power controller (SSPC) suitable for 1-phase operation, in accordance with one or more embodiments of the present disclosure.

FIG. 2B is a conceptual schematic view of an SSPC suitable for 3-phase operation, in accordance with one or more embodiments of the present disclosure.

FIG. 3 is a flow diagram illustrating steps performed in a method for dynamic power delivery, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for dynamic power management in high-power and/or high reliability systems using solid-state power controllers (SSPCs), where the SSPCs are connected to various loads to enable rapid connection or disconnection of any of the various loads from an input power source or input power network. Additional embodiments of the present disclosure are directed to utilizing SSPCs to manage the connection and disconnection of loads to minimize wear. For example, some embodiments are directed to solid-state power control with soft-start capabilities to provide dynamic control of loads including, but not limited to, power transformers, while mitigating or eliminating in-rush currents to provide high operational reliability and product lifetimes.

It is contemplated herein that dynamic load control may be useful in various applications. As a non-limiting illustration, power distribution systems may sell or provide power with performance specifications such as, but not limited to, specifications of reliability or uptime. For example, power uptime may be specified by a number of nines such that 3 nines corresponds to 99.9% uptime, 5 nines corresponds to 99.999% uptime, and so on. To meet these uptime levels, a power distribution system may provide excess capacity to provide power in case of a failure of a primary input power source. However, as the uptime requirements increase, this excess capacity may become substantial such that it may be desirable for the power distribution system to provide power at different uptime levels. In this way, the power distribution system may selectively disconnect and reconnect loads to ensure a specified uptime for all available loads. As an illustration, such a power distribution system may selectively disconnect one or more loads specified at a lower uptime level (e.g., 3 nines) as necessary to ensure operation of loads at a higher uptime level (e.g., 5 nines) based on operational requirements such as, but not limited to, increased demand by loads at the higher uptime level or decreased performance of an input power network. As another non-limiting illustration, reliability may be specified by a metric such as, but not limited to, mean time between failures. As another non-limiting illustration, power distribution systems may sell or provide power with different billing or cost specifications. For instance, certain loads may be subject to a fixed resource allocation (e.g., fixed on-time, fixed electricity costs, or the like) and disconnected when this resource allocation is met and then potentially reconnected as appropriate. In another instances, certain power may be sold or provided in tiers that allow for reduced uptime requirements or complete disconnection during times of peak energy usage in exchange for cost savings. The power distribution system may then selectively disconnect and connect such loads as necessary to balance the various performance specifications.

In some embodiments, a power distribution system includes one or more SSPCs connected to an input power network, where each SSPC is further connected to at least one load. In this way, the SSPCs may dynamically connect or disconnect the associated loads from the input power network in a controlled manner (e.g., using soft-start techniques). The power distribution system may additionally include a controller coupled to the SSPCs to provide control of various aspects of the operation of the SSPCs such as, but not limited to, connecting loads to the input power network, disconnecting loads from the power network, or analyzing feedback from connected components. In some embodiments, the controller further provides remote operation of power distribution system.

It is further contemplated herein that rapid connections and disconnections from an input power source present various challenges, particularly when a load is powered through a power transformer. In particular, rapid voltage changes may induce large in-rush currents that may cause wear on both the power transformer and connected loads. Accordingly, a power distribution system including SSPCs may connect and/or disconnect loads using controlled voltage profiles to mitigate, and in some cases eliminate, such in-rush currents.

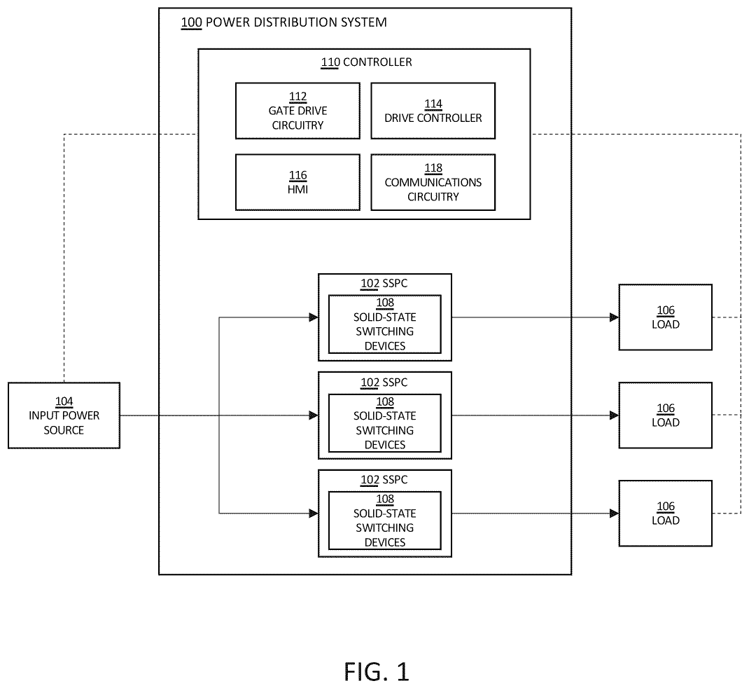

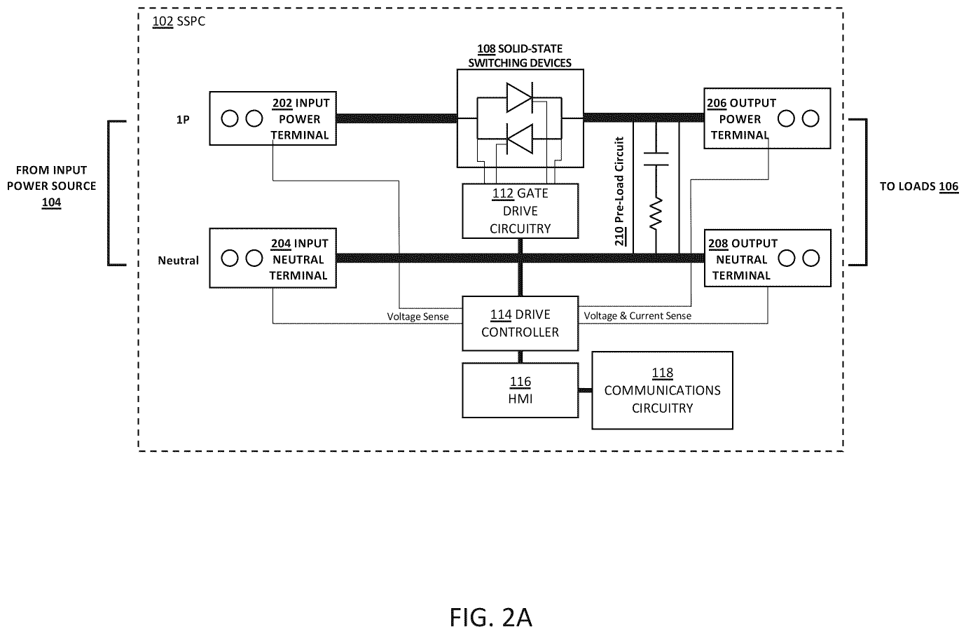

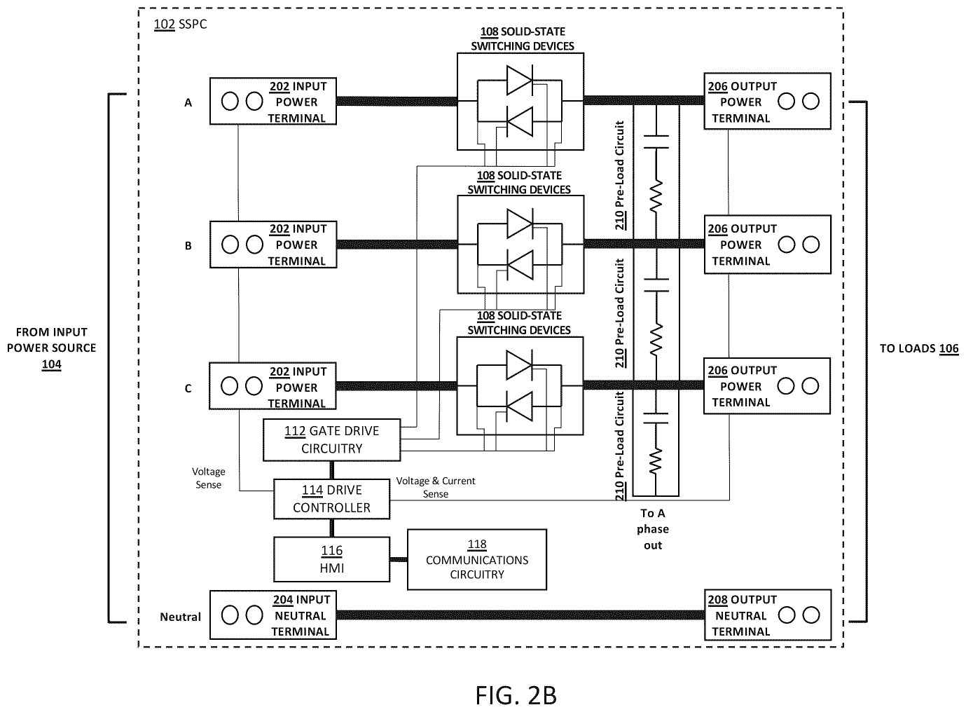

Referring now to FIGS. 1-2B, systems and methods for power distribution are described in greater detail, in accordance with one or more embodiments of the present disclosure.

FIG. 1 is a block diagram view of a power distribution system 100, in accordance with one or more embodiments of the present disclosure.

In some embodiments, the power distribution system 100 includes two or more SSPCs 102 to regulate power from an input power source 104 to two or more loads 106, where each SSPC 102 may be configured to connect to one of the two or more loads 106. For example, FIG. 1 illustrates a power distribution system 100 including three SSPCs 102 to provide dynamic control of three loads 106. Further, it is to be understood that any particular load 106 may be associated with a single load device (e.g., a single piece of equipment) or multiple load devices. For example, multiple load devices may be jointly powered by a power distribution unit (PDU) connected between the load devices and an associated SSPC 102.

An SSPC 102 may include any number or type of solid-state switching devices 108 and associated circuitry suitable for regulating power from the input power source 104 to an attached load 106 such as, but not limited to, silicon controlled rectifiers (SCRs) or insulated-gate bipolar transistors (IGBTs). For example, an SSPC 102 may include pairs solid-state switching devices 108 in a full wave power bridge configuration. Further, an SSPC 102 may include additional elements such as, but not limited to, snubber circuits, pre-load circuits, or the like.

In some embodiments, the power distribution system 100 further includes one or more controllers 110 that are communicatively coupled to at least the SSPCs 102. In this way, the controllers 110 may direct the operation of the SSPCs 102 (e.g., via control signals) and thus direct the flow of power from the input power source 104 to the various loads 106. A controller 110 may include any number of processors or processing elements known in the art. For example, a controller 110 may include one or more processing or logic elements such as, but not limited to, one or more micro-processor devices, one or more digital signal processors (DSPs), one or more field programmable gate arrays (FPGAs), one or more complex programmable logic devices (CPLDs), or one or more application specific integrated circuit (ASIC) devices. A controller 110 may further include one or more memory devices. A memory device may further include any storage medium known in the art suitable for storing program instructions executable by the associated processors such as a non-transitory memory medium including, but not limited to, a read-only memory (ROM) or a random-access memory (RAM). In this way, the processors may execute program instructions stored on the storage medium.

In some embodiments, a controller 110 includes various components suitable for driving one or more SSPCs 102 or components therein. For example, a controller 110 may include gate drive circuitry 112 (e.g., gate drivers) to drive the solid-state switching devices 108 in an SSPC 102. By way of another example, a controller 110 may include a drive controller 114 (e.g., a DSP or other processing device) to generate drive signals for the gate drive circuitry 112. In this way, the drive controller 114 may control the operation of solid-state switching devices 108 through the gate drive circuitry 112 based on operational needs. The gate drive circuitry 112 may include any number or type of components suitable for accepting drive signals from a controller 110 (e.g., logic signals, or the like) and providing requisite current or voltage to control the operation of the solid-state switching devices 108 of an SSPC 102. As an illustration, the gate drive circuitry 112 may include, but is not limited to, a low-side driver, a high-side/low-side driver, a single-channel driver, a half-bridge driver, a three-phase driver, or the like. In some embodiments, the gate drive circuitry 112 and/or the drive controller 114 are configured to provide controlled connection and/or disconnection of loads 106. For example, the gate drive circuitry 112 and/or the drive controller 114 may be configured to implement soft-starting when powering loads 106 with power transformers to mitigate or eliminate in-rush currents.

It is contemplated herein that the one or more controllers 110 may be distributed among or integrated with any number of components of the power distribution system 100 including, but not limited to, any of the SSPCs 102. In this way, any illustrations herein depicting components of a controller 110 are provided solely for illustrative purposes and should not be interpreted as limiting. For example, the power distribution system 100 may include a single controller 110 to drive any number of SSPCs 102. By way of another example, a controller 110 (or a portion thereof) may be integrated with any of the SSPCs 102 of the power distribution system 100. By way of another example, various control aspects may be distributed. For instance, the power distribution system 100 may include a master controller 110 coupled to the SSPCs 102 to control power flow to the various loads 106 (e.g., to ensure operation of the loads 106 at specified performance specifications), where each of the SSPCs 102 includes an internal controller 110 with gate drive circuitry 112 and an associated drive controller 114.

In some embodiments, one or more controllers 110 include a human-machine interface (HMI) 116 and/or may be configured for remote operation through communications circuitry 118. For example, an HMI 116 may include a display used to display data of the power distribution system 100 (e.g., data associated with operational status or loading conditions (e.g., high, low, abnormal, or the like). The display of the HMI 116 may include any display known in the art. For example, the display may include, but is not limited to, a liquid crystal display (LCD), a light emitting diode (LED) display, an organic LED (OLED) based display, or a CRT display. Those skilled in the art should recognize that any display device capable of integration with the HMI 116 is suitable for implementation in the present disclosure. By way of another example, the HMI 116 may include an input device to receive selections and/or instructions from a user such as, but not limited to, a, keyboard, a mouse, or a touchscreen interface.

In some embodiments, the power distribution system 100 controls power to one or more loads 106 at least partially based on feedback from connected components such as, but not limited to, the input power source 104 or the one or more loads 106.

For example, the feedback may include operational conditions of the loads 106 such as, but not limited to, past, current, or anticipated load conditions. As another example, the feedback may include operational conditions of the input power source 104 such as, but not limited to, past, current, or anticipated power supply conditions. Such feedback may be generated through monitoring circuitry within the power distribution system 100 (e.g., voltage monitoring circuitry, current monitoring circuitry, or the like), from the HMI 116, or received from an external system (e.g., the input power source 104, a load 106, external monitoring circuitry, or the like). In this way, the power distribution system 100 may selectively connect or disconnect any of the loads 106 based on dynamically changing conditions from the input power source 104 and/or any of the loads 106 as necessary to meet performance specifications.

Referring now to FIGS. 2A and 2B, it is contemplated herein that an SSPC 102 may be configured for single-phase or multi-phase operation.

FIG. 2A is a conceptual schematic view of an SSPC 102 suitable for 1-phase operation, in accordance with one or more embodiments of the present disclosure. In this configuration, the SSPC 102 may include an input power terminal 202 (here labeled as 1P) and an input neutral terminal 204 to receive input power from the input power source 104. In some embodiments, the SSPC 102 may include solid-state switching devices 108 connected to the input power terminal 202 to regulate power to an output power terminal 206 with respect to an output neutral terminal 208. FIG. 2A further illustrates a pre-load circuit 210 between the output power terminal 206 and the output neutral terminal 208.

FIG. 2B is a conceptual schematic view of an SSPC 102 suitable for 3-phase operation, in accordance with one or more embodiments of the present disclosure. In this configuration, the SSPC 102 may include three input power terminals 202 (here labeled A, B, and C) and three output power terminals 206 for 3-phase power. In some embodiments, as illustrated in FIG. 2B, the SSPC 102 includes solid-state switching devices 108 for each phase. In some embodiments, though not shown, an SSPC 102 may further include solid-state switching devices 108 on the neutral line (e.g., between the input neutral terminal 204 and the output neutral terminal 208).

Referring generally to FIGS. 2A and 2B, it is to be understood that FIGS. 2A and 2B, and the associated descriptions, are provided solely for illustrative purposes and should not be interpreted as limiting. For example, FIGS. 2A and 2B illustrate various aspects of a controller 110 integrated within the SSPC 102. However, as described previously herein, such components (or portions thereof) may also be provided external to any particular SSPC 102.

Further, it is contemplated herein that the input power source 104 may generally include any number of sources of input power such as, but not limited to, a utility connection, a generator, an uninterruptible power supply (UPS), or the like. For example, the input power source 104 may include at least one primary source and at least one backup source to provide power in case of failure or diminished performance of a primary source. In such a configuration, the input power source 104 may further include, but is not required to include, various solid-state power controlling components to selectively control which source of input power is directed to the power distribution system 100. The use of SSPCs for switching power supplied to a load between available input sources is generally described in U.S. Pat. No. 11,171,508 issued on Nov. 9, 2021, U.S. Pat. No. 10,903,649 issued on Jan. 26, 2021, and International Patent Publication No. WO 2014/158065 published on Oct. 2, 2014, all of which are incorporated herein by reference in their entireties.

Referring now generally to FIGS. 1-2B, various implementations of the power distribution system 100 are described in greater detail, in accordance with one or more embodiments of the present disclosure.

It is contemplated herein that the power distribution system 100 facilitates dynamic power control to various loads 106 and may be suitable for a wide variety of applications. Further, the use of SSPCs 102 for load control enables soft-starting of loads 106 coupled to power transformers such that the power distribution system 100 may provide excellent performance and reliability even at high-power operation. In particular, the solid-state switching devices 108 as disclosed herein may be particularly well suited for, but are not limited to, applications in which loads 106 are dynamically connected to and/or disconnected from an input power source 104.

In some embodiments, different SSPCs 102 may provide different performance specifications to attached loads 106, where the performance specifications may include, but are not limited to, an uptime specification, a reliability specification, a billing specification, or a cost specification. In such configurations, the power distribution system 100 may prioritize the operation of loads 106 (e.g., via the SSPCs 102) based on the performance specifications. As an illustration, the power distribution system 100 may be configured to provide a first performance specification of 5 nines of uptime (99.999% uptime) to a first load 106 connected to a first SSPC 102 and a second performance specification of 3 nines of uptime (99.9% uptime) to a second load 106 connected to a second SSPC 102 (e.g., the performance specification of the first SSPC 106 is stricter than the performance specification of the second SSPC 106). In this configuration, the power distribution system 100 may selectively disconnect (e.g., shed) the load 106 as necessary to ensure that the first SSPC 102 continues to achieve its performance specification. For instance, it may be necessary to disconnect the load 106 attached to the second SSPC 102 if the input power source 104 has insufficient capacity to provide adequate power to both the first and second loads 106 for any reason such as, but not limited to, increased demand by the first load 106 or diminished performance of the input power source 104. Further, the power distribution system 100 may reconnect the second load 106 when the input power source 104 has sufficient capacity to power both the first and second loads 106.

This approach can be extended to any number of performance specifications. As another illustration, power distribution systems may sell or provide power with different billing or cost specifications. In this way, the power distribution system 100 may selectively disconnect or connect various loads to ensure the reliability specification for each is met. As another illustration, a billing specification may be associated with resource allocations for one or more loads 106. In this configuration, the power distribution system 100 may selectively disconnect various loads 106 when an allotted resource allocation is met and reconnect the loads 106 when the allotted resource allocation modified. As another illustration, a cost specification may be attributed to one or more loads 106 that provide guidelines for cost saving measures (e.g., based on customer consent). For instance, a cost specification may dictate that particular loads 106 may be shut down or may have a reduced uptime specification during times of peak electricity usage (e.g., in exchange for cost savings or any other arrangement). In this configuration, the power distribution system 100 may selectively disconnect and connect various loads 106 based on the associated cost specifications. In a general sense, the power distribution system 100 may selectively and dynamically disconnect or connect to meet any combination of performance specifications.

In some embodiments, different SSPCs 102 may provide the same performance specifications to attached loads 106. In this configuration, the power distribution system 100 may utilize the SSPCs 102 to balance the power distribution, or disruptions thereof, between the various attached loads 106. For example, the power distribution system 100 may rotate temporary disconnections between the various SSPCs 102 to balance the power distribution to the various attached loads 106.

Further, the power distribution system 100 may receive input from any number of sources (e.g., as feedback) for power control. For example, the power distribution system 100 may allow manual control by a user, which may be local or remote. As an illustration, the power distribution system 100 may provide information associated with load levels for various loads 106 attached to any of the SSPCs 102. Such information may be in the form of data, performance categories (e.g., high, low, abnormal, or the like), or any other suitable form. A user may then selectively control the SSPCs 102 to connect or disconnect various loads 106. Further, the power distribution system 100 may provide alerts (e.g., audio alerts, visual alerts, or the like) (e.g., when the feedback data deviates beyond a selected threshold) using the HMI 116 when selected conditions are met (e.g., loading conditions (e.g., current or future power demand) of any of the loads 106, diminished performance or capacity of the input power source 104, or the like). By way of another example, the power distribution system 100 may receive switching criteria associated with when and/or how to implement disconnections or connections of the loads 106. For instance, switching criteria may include, but are not limited to, start and stop conditions or thresholds (e.g., connection and disconnection conditions) for any of the loads 106, delays after conditions or thresholds are met, or the like. Further, such switching criteria may be pre-loaded on the power distribution system 100 and/or configurable by a user (e.g., via the HMI 116). By way of another example, the power distribution system 100 may provide automated control based on any combination of inputs conditions or feedback more generally (e.g., start and stop conditions, delay levels after specific thresholds have been reached, or the like).

It is further contemplated herein that the power distribution system 100 may be implemented in various ways within the spirit and scope of the present disclosure. For example, the power distribution system 100 may be coupled to or integrated with a power distribution unit (PDU) used to provide power to multiple loads 106. In some embodiments, an SSPC 102 is provided as a stand-alone component on an upstream side of a PDU (e.g., a “line-side”) to control loads 106 connected downstream of the PDU. In some embodiments, an SSPC 102 is integrated into a PDU (e.g., into a line-side of the PDU). In some embodiments, an SSPC 102 is provided within a switch gear lineup.

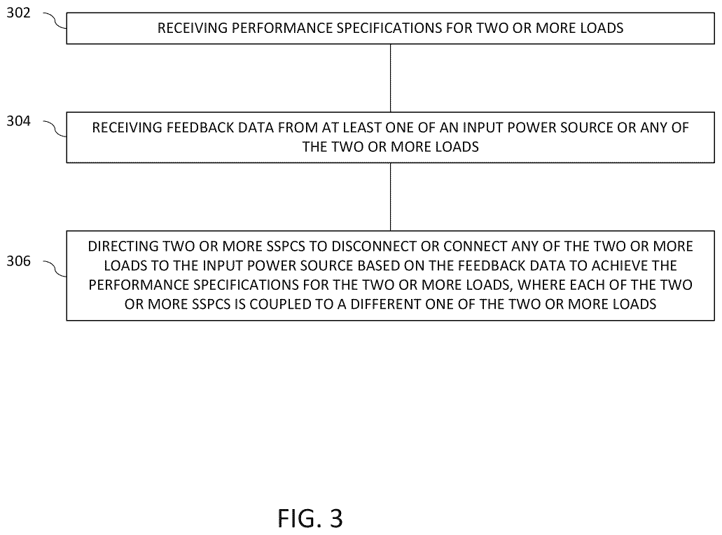

Referring now to FIG. 3, FIG. 3 is a flow diagram illustrating steps performed in a method 300 for dynamic power delivery, in accordance with one or more embodiments of the present disclosure. Applicant notes that the embodiments and enabling technologies described previously herein in the context of the power distribution system 100 should be interpreted to extend to the method 300. It is further noted, however, that the method 300 is not limited to the architecture of the power distribution system 100.

In some embodiments, the method 300 includes a step 302 of receiving performance specifications for two or more loads 106. The performance specifications may generally include performance requirements for each of the loads 106 such as, but not limited to, uptime or reliability requirements. Further, the performance parameters of the various loads 106 may be the same, may be different, or may change over time.

In some embodiments, the method 300 includes a step 304 of receiving feedback data from at least one of an input power source 104 or any of the two or more loads 106. In some embodiments, the method 300 includes a step 306 of directing two or more SSPCs 102 to disconnect or connect any of the two or more loads 106 to the input power source 104 based on the feedback data to achieve the performance specifications for the two or more loads 106, where each of the two or more SSPCs 102 is coupled to a different one of the two or more loads 106 (e.g., maintaining an in-rush current below a selected threshold when disconnecting or connecting any of the two or more loads to the power source).

For example, feedback data associated with the input power source 104 may include past, current, or anticipated power conditions provided or anticipated by the input power source 104. In this way, such feedback data may be used to dynamically balance power to the loads 106 (e.g., selectively connect or disconnect any of the loads 106) to meet the performance specifications of the loads 106 based on the feedback data associated with available power from the input power source 104. As another example, feedback data associated with the loads 106 may include past, current, or anticipated load conditions for any of the loads 106. In this way, such feedback data may be used to dynamically balance power to the loads 106 (e.g., selectively connect or disconnect any of the loads 106) to meet the performance specifications of all of the loads 106 based on the feedback data associated with changing load conditions for any of the loads 106.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A power distribution system comprising:
two or more solid-state power controllers (SSPCs) configured to regulate power between an input power source and two or more loads, wherein each of the two or more SSPCs is configured to be coupled to a different one of the two or more loads;
a controller communicatively coupled to the two or more SSPCs, the controller including one or more processors configured to execute program instructions causing the one or more processors:
receive performance specifications for the two or more loads;
receive feedback data from at least one of the input power source or any of the two or more loads; and
direct the two or more SSPCs to disconnect or connect any of the two or more loads to the input power source based on the feedback data to achieve the performance specifications for the two or more loads.

2. The power distribution system of claim 1, wherein the two or more SSPCs include at least a first SSPC providing a first performance specification and a second SSPC providing a second performance specification, wherein the first performance specification is stricter than the second performance specification, wherein directing the two or more SSPCs to disconnect or connect any of the two or more loads to the input power source based on the feedback data to achieve the performance specifications for the two or more loads comprises:
directing the second SSPC to disconnect an attached one of the two or more loads based on the feedback data to achieve the first performance specification with the first SSPC when the input power source has insufficient capacity to power first and second loads.

3. The power distribution system of claim 2, wherein directing the two or more SSPCs to disconnect or connect any of the two or more loads to the input power source based on the feedback data to achieve the performance specifications for the two or more loads further comprises:
directing the second SSPC to connect the attached one of the two or more loads based on the feedback data when the input power source has sufficient capacity to power the first and second loads.

4. The power distribution system of claim 1, wherein the performance specifications include at least one of uptime or reliability specifications for the two or more loads.

5. The power distribution system of claim 1, wherein the performance specifications Include at least one of billing specifications or cost specifications for the two or more loads.

6. The power distribution system of claim 1, wherein the feedback data includes at least one of past, current, or anticipated load conditions of any of the two or more loads.

7. The power distribution system of claim 1, wherein the feedback data includes at least one of past, current, or anticipated power conditions of the input power source.

8. The power distribution system of claim 1, wherein directing the two or more SSPCs to disconnect or connect any of the two or more loads to the input power source based on the feedback data to achieve the performance specifications for the two or more loads comprises:
maintaining an in-rush current below a selected threshold when disconnecting or connecting any of the two or more loads to the power source.

9. The power distribution system of claim 1, further comprising:
a human-machine interface (HMI) communicatively coupled to the controller.

10. The power distribution system of claim 9, wherein the HMI displays at least a portion of the feedback data.

11. The power distribution system of claim 9, wherein the HMI provides an alert when the feedback data deviates beyond a selected threshold.

12. The power distribution system of claim 9, wherein the HMI further includes an input device to accept a user input, wherein the user input includes switching criteria for achieving the performance specifications for the two or more loads, wherein directing the two or more SSPCs to disconnect or connect any of the two or more loads to the input power source based on the feedback data to achieve the performance specifications for the two or more loads further comprises:
directing the two or more SSPCs to disconnect or connect any of the two or more loads to the input power source in accordance with the switching criteria to achieve the performance specifications for the two or more loads.

13. The power distribution system of claim 1, wherein at least one of the two or more loads comprises:
two or more load devices connected to a power distribution unit.

14. A power distribution method comprising:
receiving performance specifications for two or more loads;
receiving feedback data from at least one of an input power source or any of the two or more loads; and
directing two or more SSPCs to disconnect or connect any of the two or more loads to the input power source based on the feedback data to achieve the performance specifications for the two or more loads, wherein each of the two or more SSPCs is coupled to a different one of the two or more loads.

15. The power distribution method of claim 14, wherein the two or more SSPCs include at least a first SSPC providing a first performance specification and a second SSPC providing a second performance specification, wherein the first performance specification is stricter than the second performance specification, wherein directing the two or more SSPCs to disconnect or connect any of the two or more loads to the input power source based on the feedback data to achieve the performance specifications for the two or more loads comprises:
directing the second SSPC to disconnect an attached one of the two or more loads based on the feedback data to achieve the first performance specification with the first SSPC when the input power source has insufficient capacity to power the first and second loads.

16. The power distribution method of claim 15, wherein directing the two or more SSPCs to disconnect or connect any of the two or more loads to the input power source based on the feedback data to achieve the performance specifications for the two or more loads further comprises:
directing the second SSPC to connect the attached one of the two or more loads based on the feedback data when the input power source has sufficient capacity to power the first and second loads.

17. The power distribution method of claim 14, wherein the performance specifications include at least one of uptime specifications, reliability specifications, billing specifications, or cost specifications for the two or more loads.

18. The power distribution method of claim 14, wherein the feedback data includes at least one of past, current, or anticipated load conditions of any of the two or more loads.

19. The power distribution method of claim 14, wherein the feedback data includes at least one of past, current, or anticipated power conditions of the input power source.

20. The power distribution method of claim 14, wherein directing the two or more SSPCs to disconnect or connect any of the two or more loads to the input power source based on the feedback data to achieve the performance specifications for the two or more loads comprises:
maintaining an in-rush current below a selected threshold when disconnecting or connecting any of the two or more loads to the power source.
